(19) United States
(12) Patent Application Publication
(10) Pub. No.: US 2017/0282655 A1
(43) Pub. Date: Oct. 5, 2017

(54) TIRE PRESSURE MONITORING SYSTEM AND METHOD

(71) Applicant: Silergy Semiconductor Technology (Hangzhou) LTD, Hangzhou (CN)

(72) Inventors: Chi-Kang Liu, Hangzhou (CN); Michael Grimm, Los Altos Hills, CA (US)

(21) Appl. No.: 15/471,074

(22) Filed: Mar. 28, 2017

(30) Foreign Application Priority Data
Mar. 29, 2016 (CN) 201610188747.3

(51) Int. Cl. B60C 23/04

(52) U.S. Cl. CPC B60C 23/0483

(57) ABSTRACT

A tire pressure monitor can include: a wireless transmitting port wirelessly coupled to a first air pressure sensor arranged inside of a tire of a vehicle, where the wireless transmitting port is configured to receive an internal air pressure from the first air pressure sensor; and a controller coupled to the first wireless transmitting port, where the controller is configured to determine a current tire pressure in accordance with a difference between the internal air pressure and an external air pressure outside of the tire. voltage signals, and an output terminal for

### RELATED APPLICATIONS

This application claims the benefit of Chinese Patent Application No. 201610188747.3, filed on Mar. 29, 2016, which is incorporated herein by reference in its entirety.

### FIELD OF THE INVENTION

The present invention generally relates to the field of pressure monitoring, and in particular to tire pressure monitoring systems and methods.

### BACKGROUND

Tire pressure monitoring systems (TPMS) can be used to monitor the status of tires by recording the tire speed or by use of electronic sensors in the tires, in order to provide effective safety for the driving of motor vehicles. In one approach, an indirect tire pressure monitoring system can be used to determine whether the tire pressure is normal by the rotating speed difference. In another approach, a direct tire pressure monitoring system can utilize air pressure monitoring and temperature sensors in the tires. The air pressure and temperature of the tires may be monitored when the motor vehicles are driving or stationary. Alarms may go off when the tires are in a dangerous state (e.g., high pressure, low pressure, high temperature, etc.), in order to avoid potential traffic accidents caused thereby.

### BRIEF DESCRIPTION OF THE DRAWINGS

FIG. 1 is a flow diagram of an example method of monitoring tire pressure, in accordance with embodiments of the present invention.

FIG. 2 is a schematic block diagram of a first example tire pressure monitoring system, in accordance with embodiments of the present invention.

FIG. 3 is a schematic block diagram of a second example tire pressure monitoring system, in accordance with embodiments of the present invention.

FIG. 4 is a schematic block diagram of a third example tire pressure monitoring system, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Direct tire pressure monitoring systems may only monitor the absolute tire pressure in the tires, and the external air pressure difference caused by the temperature or altitude to the tire pressure may not be considered. Therefore, in some cases, tire rupture may occur before an alarm is sent out by such a tire pressure monitoring system, which can result in potential safety threats.

In one embodiment, a method of monitoring tire pressure can include: (i) determining an external air pressure outside of a tire of a vehicle; (ii) monitoring an internal air pressure inside of the tire; and (iii) determining, by a controller, a current tire pressure of the tire in accordance with a difference between the internal air pressure and the external air pressure.

In one embodiment, a tire pressure monitor can include: (i) a wireless transmitting port wirelessly coupled to a first air pressure sensor arranged inside of a tire of a vehicle, where the wireless transmitting port is configured to receive an internal air pressure from the first air pressure sensor; and (ii) a controller coupled to the first wireless transmitting port, where the controller is configured to determine a current tire pressure in accordance with a difference between the internal air pressure and an external air pressure outside of the tire.

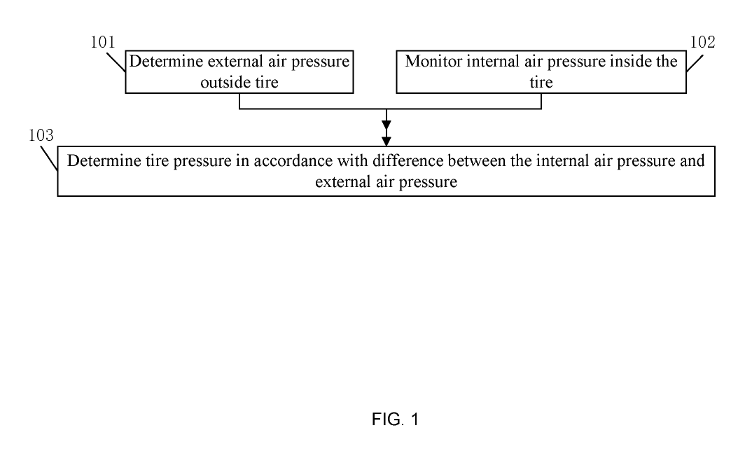

Referring now to FIG. 1, shown is a flow diagram of an example method of monitoring tire pressure, in accordance with embodiments of the present invention. At 101, the air pressure outside the tire can be obtained. Because the air pressure outside the tire may vary along with the altitude or temperature, the air pressure outside tire should be considered in order to achieve accurate tire pressure monitoring. For example, an air pressure sensor can be arranged outside the tire to detect the external air pressure, in order to detect the air pressure outside the tire. In addition, the current altitude can be determined by using a positioning system (e.g., global positioning system [GPS], etc.), in order to determine the external air pressure of the tires according to the current altitude.

At 102, the air pressure inside the tire can be determined. For example, an air pressure sensor can be arranged inside each of the tires, in order to detect the internal air pressure of the tires. In addition, a temperature sensor can also be arranged inside each of the tires. Therefore, both internal air pressure and temperature can be monitored in real time, in order to further determine the safety of tires to improve the safe driving of vehicles. Note that steps 101 and 102 can occur simultaneously, and may be ongoing throughout operation of the vehicle. In some cases, the tire monitoring according to particular embodiments can occur always so long as power is available.

At 103, the current tire pressure can be obtained in accordance with the difference between the internal and external air pressures of each of the tires. This is in contrast to other approaches whereby the displayed value of the TPMS is the difference between the internal air pressure and a fixed value, which is normally set as standard atmospheric pressure at zero altitude. In actual applications, when a motor vehicle drives from level ground to an elevated mountainside, the external air pressure outside tires is decreased. However, because the variation of external air pressure is not considered in such cases, the tires may in fact rupture before the TPMS can send out alarms. In particular embodiments, because both internal and external air pressures of each tire are considered in tire pressure monitoring, a more accurate reading of tire pressures can be achieved, resulting in improved safety performance.

In one particular example of Goodyear tires, a data comparison is shown below in Table 1. Here, maximum allowable tire pressure may be 44 psi. On level ground, when the external air pressure outside the tires is 14.69 psi, and the internal air pressure inside tires is 50.69 psi, the tire pressured obtained by the TPMS is the difference between the two air pressures of 36 psi. When at an altitude of 1000 m, the external air pressure outside tires is 14.69 psi, and the internal air pressure inside tires is still 50.69 psi, the tire pressured obtained by the TPMS is the difference between the two air pressures of 37.75 psi.

When at an altitude of 5000 m, the external air pressure outside tires is 7.55 psi, and internal air pressure inside tires is still 50.69 psi, the tire pressured obtained by the TPMS is the difference between the two air pressures of 43.14 psi. However, the displaying value of tire pressure by a standard TPMS in this example is still 36 psi, thus representing a huge difference between the displaying value and the actual value of the tire pressure. As a result, the tire may be ruptured before the TPMS sends out alarms, which can result in huge potential safety problems. However, in particular embodiments, the actual tire pressure can be monitored more accurately in order to improve the safety and reliability of the tires.

TABLE 1

| | | | | |
|---|---|---|---|---|
| Altitude (m) | 0 | 1000 | 3000 | 5000 |
| Internal air pressure | 50.69 | 50.69 | 50.69 | 50.69 |
| inside tire (psi) | | | | |
| External air | 14.69 | 12.94 | 9.80 | 7.55 |
| pressure outside tire | | | | |
| (psi) | | | | |
| Standard tire | 50.69 − 14.69 = 36.00 | 50.69 − 14.69 = 36.00 | 50.69 − 14.69 = 36.00 | 50.69 − 14.69 = 36.00 |
| pressure monitoring | | | | |
| (psi) | | | | |
| Tire pressure | 50.69 − 14.69 = 36.00 | 50.69 − 12.94 = 37.75 | 50.69 − 9.80 = 40.89 | 50.69 − 7.55 = 43.14 |
| monitored in | | | | |
| accordance with | | | | |
| particular | | | | |
| embodiments (psi) | | | | |

In particular embodiments, the variation of the external air pressure outside tire caused by altitude and temperature can be well detected, in order to obtain more accurate external air pressure. As a result, the tire pressure can be more accurately obtained in accordance with the difference between the internal air pressure and the external air pressure, which can improve safety and reliability performance.

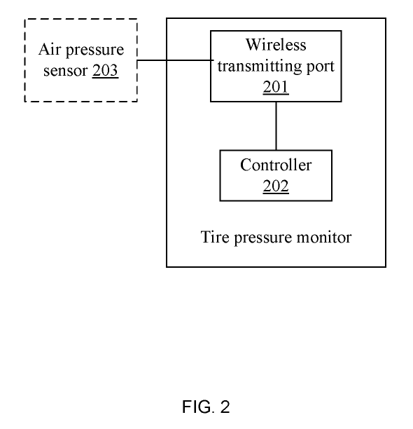

Referring now to FIG. 2, shown is a schematic block diagram of a first example tire pressure monitoring system, in accordance with embodiments of the present invention. This particular example tire pressure monitor can include wireless transmitting port 201 and controller 202. Wireless transmitting port 201 can be wirelessly coupled to air pressure sensor 203 arranged inside the tires, in order to transfer the internal air pressure measured from inside the tires to controller 202. Controller 202 (e.g., a central processing unit [CPU], microcontroller, etc.) can determine the accurate tire pressure in accordance with the difference between the internal air pressure and external air pressure.

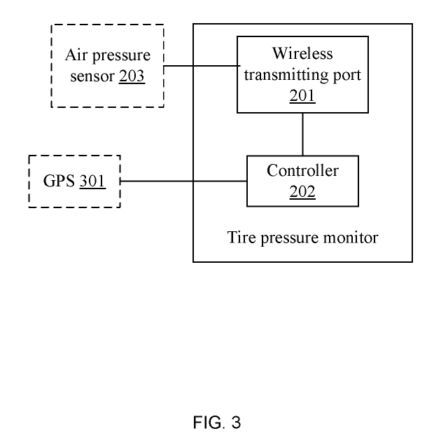

Referring now to FIG. 3, shown is a schematic block diagram of a second example tire pressure monitoring system, in accordance with embodiments of the present invention. In this particular example, controller 202 can be coupled to GPS 301 of the motor vehicle in order to determine the altitude. The external air pressure can be correspondingly obtained according to the altitude by controller 202.

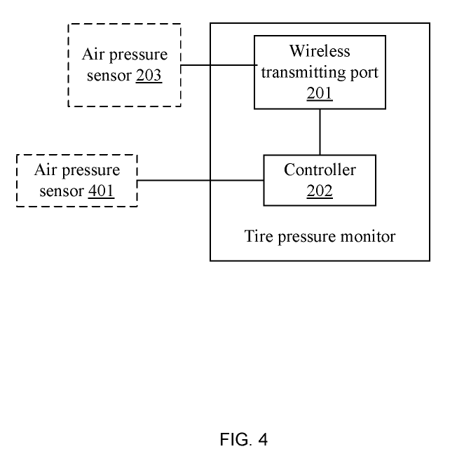

Referring now to FIG. 4, shown is a schematic block diagram of a third example tire pressure monitoring system, in accordance with embodiments of the present invention. In this particular example, controller 202 can be coupled to air pressure sensor 401 arranged outside the tire, and configured to monitor the external air pressure in real time.

Particular embodiments can also include a display screen coupled to controller 202, and configured to display the tire pressure obtained by the TPMS. In addition, the internal temperature inside the tire, the supply voltage of the TPMS, and other parameters corresponding to tire safety, can also be displayed on the display screen, in order to achieve more comprehensive safety monitoring. Further, the TPMS of the particular embodiments can be supplied by a separate battery, or a direct current supply voltage of the motor vehicle.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A method of monitoring tire pressure, the method comprising:
a) determining an external air pressure outside of a tire of a vehicle;
b) monitoring an internal air pressure inside of said tire; and
c) determining, by a controller, a current tire pressure of said tire in accordance with a difference between said internal air pressure and said external air pressure.

2. The method of claim 1, wherein said determining said external air pressure comprises using an air pressure sensor configured outside of said tire.

3. The method of claim 1, wherein said determining said external air pressure comprises:
a) determining, by a positioning system, a current altitude of said vehicle; and
b) determining said external air pressure outside of said tire in accordance with said current altitude.

4. The method of claim 1, wherein said monitoring said internal air pressure comprises using an air pressure sensor configured inside of said tire.

5. A tire pressure monitor, comprising:
a) a wireless transmitting port wirelessly coupled to a first air pressure sensor arranged inside of a tire of a vehicle, wherein said wireless transmitting port is configured to receive an internal air pressure from said first air pressure sensor; and
b) a controller coupled to said first wireless transmitting port, wherein said controller is configured to determine a current tire pressure in accordance with a difference between said internal air pressure and an external air pressure outside of said tire.

6. The air pressure monitor of claim 5, wherein said controller is coupled to a positioning system used to determine an altitude of said vehicle, and wherein said controller is configured to determine said external air pressure outside of said tire in accordance with said altitude.

7. The air pressure monitor of claim 5, further comprising a second air pressure sensor arranged outside of said tire, wherein said second air pressure sensor is configured to detect said external air pressure.

8. The air pressure monitor of claim 5, further comprising a display screen coupled to said controller for displaying said tire pressure from said controller.

9. The air pressure monitor of claim 5, wherein a battery of said vehicle is configured to supply power to said air pressure monitor.
